(19) United States
(12) Patent Application Publication
(10) Pub. No.: US 2009/0235778 A1
(43) Pub. Date: Sep. 24, 2009

(54) POSITIONING SHOE RETAINER ASSEMBLY OF BICYCLE

(76) Inventor: Chung-I Chen, Taichung Hsien (TW)

Correspondence Address: Chien-Hui Su, P. O. Box 70-121 Taichung, Taichung City, 40899, TW

(21) Appl. No.: 12/052,751

(22) Filed: Mar. 21, 2008

(51) Int. Cl. B62M 3/08

(52) U.S. Cl. 74/594.6

(57) ABSTRACT

A positioning shoe retainer assembly of a bicycle comprises a shoe retainer and a pedal. The shoe retainer has a retaining portion which is installed with at least one engaging hole for retaining. An arc portion is extending from the retaining portion; an inner side of the arc portion being formed with a receiving portion. The arc portion is extending with a combining portion. The combining seat is installed with a combining seat. At least one combining unit is extending from the combining seat 131. The pedal serves to assembled with a bicycle by connecting to a shaft of a bicycle. A surface of the pedal adjacent to the shaft is an inner lateral surface; and a surface of the pedal opposite to the inner lateral surface being an outer lateral surface. An upper surface of the pedal is formed as a treaded surface for being treaded by users.

### FIELD OF THE INVENTION

The present invention relates to bicycles, and particularly to a positioning shoe retainer assembly of a bicycle which can be actively assembled to or detached from a pedal without needing any screws.

### BACKGROUND OF THE INVENTION

Currently riding bicycle has become a popular exercise and is widely accepted by people. To make the driver steadily drive the bicycle without sliding out of the pedals and thus inducing some dangerous conditions or fail in competition, the pedal of a bicycle is installed with a toe retainer which is used with special pedal shoe. However this is inconvenient to the driver. Thus the shoe retainer is developed to improve the prior art defect.

In Taiwan Patent No. “Leg retainer assembly of a bicycle”, in that the leg retainer has a front portion for receiving a front end of a foot and a connecting portion extending from a lower end of the front portion for connecting with the pedal of a bicycle. The leg retainer is extended with a stop wall at a portion slightly in front of the connecting portion. The front wall surface of the stop wall serves for fixing a light reflector. The connecting portion and the pedal of a bicycle are combined by using screws. Thereby a leg retainer is formed by receiving legs. The prior art leg retainer uses screw for retaining so as to have the effect of completely receiving a shoe. However since the screw is used and thus the installation work is difficult. Especially, in competition, it is inconvenient to wear or detach the leg retains from legs.

Another improvement design is disclosed in Taiwan Patent No. 270437, “Positioning shoe for a bicycle pedal”, wherein a frame surface of a bottom of a pedal faces to an H shape body. A plurality of press sheets protrude from a distal end of the shoe with respect to the shoelace, which is vertical to the frame surface of the pedal and has a slight difference from the H shape body for passing the shoelace from the H shape body and along the upper surfaces of the press sheets so that the shoelace is horizontally arranged upon the press sheets without extending downwards. Thus, it can be worn conveniently. However although no screw is used in this leg retainer, but the user must stop, bend down and squat for wearing the press sheets to the pedal. The installation is inconvenient.

However a hollow retaining post with a hollow round cylinder and having a plurality of longitudinal slots is embedded into the pedal directly along a direction parallel to the pedal. Screws penetrate through the retaining post to lock the retainer to the lateral surface of the pedal. However the prior art structure still has screws for retaining. Screws serve to assist the leg retainer to lock upon the pedal. In installation and update, tools are needed and the user need bend down and squat for placing the leg upon the pedal. It is impractical.

### SUMMARY OF THE INVENTION

Accordingly, the object of the present invention is to provide a positioning shoe retainer assembly of a bicycle, wherein no screw is used in assembly the shoe retainer 1 to the pedal 2. Thus the user does not need to change the pose in assembly.

To achieve above object, the present invention provides a positioning shoe retainer assembly of a bicycle comprising a shoe retainer and a pedal. The shoe retainer has a retaining portion. The retaining portion is installed with at least one engaging hole for retaining; an arc portion extending from the retaining portion; an inner side of the arc portion being formed with a receiving portion; the arc portion extending with a combining portion; the combining seat being installed with a combining seat; at least one combining unit extending from the combining seat. The pedal serves to assembled with a bicycle by connecting to a shaft of a bicycle. A surface of the pedal adjacent to the shaft is an inner lateral surface; and a surface of the pedal opposite to the inner lateral surface is an outer lateral surface. An upper surface of the pedal is formed as a treaded surface for being treaded by users. Two lateral surfaces are vertical to the treaded surface, the inner lateral surface and the outer lateral surface. The pedal is formed with at least one combining groove near the lateral surface. In assembly, the shoe retainer is embedded into the combining groove of the pedal by using the combining unit so that the combining seat of the shoe retainer adheres upon the lateral surface of the pedal and the shoe retainer can separate from the pedal from a direction opposite to the direction that the shoe retainer embedded into the pedal. Thus, by the shoe retainer being movably installed to the pedal, the shoe retainer can be assembled and detached rapidly.

The prior art shoe retainer needs screws to locking the shoe retainer to the pedal or needs press sheets to pass through the pedal for assembly. Even some manufacturers improve the shoe retainer to be installed to the pedal by using hollow retaining posts, but the structure is insufficient and thus screws are necessary. The combining unit has slit and thus it is elastic. Two sides of the combining unit have positioning blocks for resisting against the walls of the combining groove. The combining groove is formed in the treaded surface or lateral surface. In use, the user only need wear the shoe retainer on the foot and then treads the pedal without needing to bend down or to squat. If the shoe retainer is not used or needs to separate from the pedal urgently, the user's foot and the shoe retainer draw from the pedal along a direction opposite to the assembly direction. In the third embodiment of the present invention, the combining unit has a dovetail shape which is assembled to the combining groove from an outer lateral surface to the inner lateral surface so as to be assembled to the combining groove. The detaching work is performed along an opposite direction. It does not affect the riding operation and the riding pose is unnecessary to be changed. Moreover, no screw is used in assembly the shoe retainer to the pedal in the present invention so that the cost is saved.

The various objects and advantages of the present invention will be more readily understood from the following detailed description when read in conjunction with the appended drawing.

### BRIEF DESCRIPTION OF THE DRAWINGS

FIG. 1 is an explosive schematic view of the first embodiment of the present invention.

FIG. 2 is as assembled schematic view about the first embodiment of the present invention.

FIG. 3 is an explosive schematic view about the second embodiment of the present invention.

FIG. 4 is an explosive schematic view about the third embodiment of the present invention.

FIGS. 5 and 6 are schematic views showing the use of the first embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

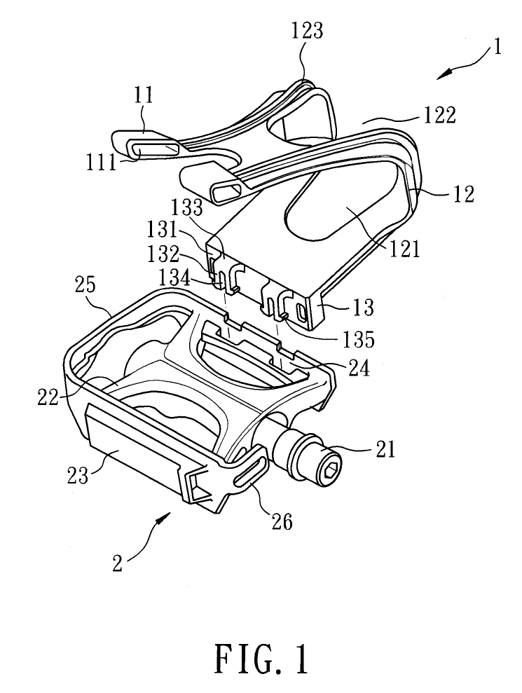

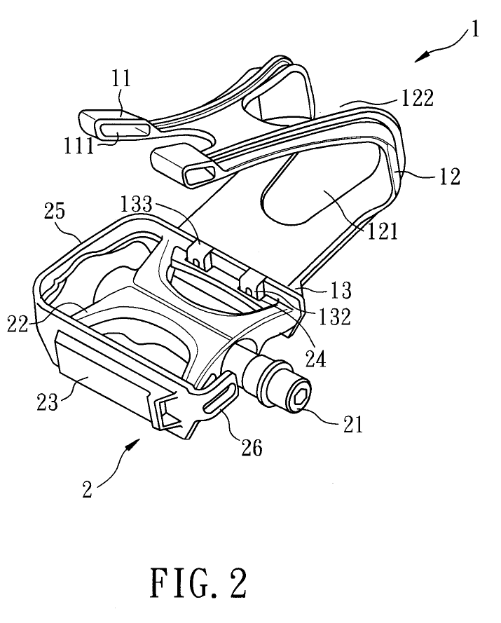

A shoe retainer assembly for a bicycle, as illustrated in FIGS. 1 and 2 includes a shoe retainer 1 and a pedal 2.

The shoe retainer 1 has a U shape structure. A bottom of the shoe retainer 1 is installed with a combining portion 13. The combining portion 13 extends upwards to form with an arc portion 12. The arc portion 12 has a receiving groove 122 so as to divide the arc portion 12 into two parts. The upper portion of the arc portion 12 is formed as two retaining portions 11. A distal end of each retaining portion 11 is formed with an engaging hole 111 for receiving a buckle stripe 3 so as to retain the foot of a user. A part of the arc portion 12 extending from the retaining portions 11 is installed with enhancing ribs 123 for enhancing the structure strength of the arc portion 12.

An inner side of the arc portion 12 is formed as a receiving portion 121. A connection of the combining portion 13 and the pedal 2 is formed with a combining seat 131. A front plane of the combining seat 131 has two combining units 132. In this embodiment, the combining units 132 are parallel to the front plane of the combining seat 131. Each combining unit 132 has a connecting section 133 which is connected to the combining seat 131. A center of each combining unit 132 is formed with a slit 134. Each of two lateral sides of the combining unit 132 is extended with a positioning block 135.

When the pedal 2 is assembled to a bicycle, the pedal 2 is pivoted with a shaft 21. An end surface of the pedal 2 pivoted to the shaft 21 is defined as an inner lateral surface 26. A side of the pedal 2 opposite to the inner lateral surface 26 is defined as an outer lateral surface 25. The pedal 2 has an upper and a lower treaded surface 22, which is the largest area in the pedal 2 for being treaded by users. A lateral surface 23 is a front surface of the pedal 2 and is approximately vertical to the treaded surface 22, the inner lateral surface 26 and outer lateral surface 25. The pedal 2 is formed with two combining grooves 24 penetrating the treaded surfaces 22 of the pedal 2 and adjacent to the lateral surface 23.

In assembly, the shoe retainer 1 is combined to the pedal 2 by the two combining units 132 being embedded into the combining groove 24 of the positioning block 135 from the upper side of the combining groove 24. The slits 134 of the combining units 132 cause the combining units 132 to be elastic. The two positioning blocks 135 are buckled into the combining groove 24 so that the combining unit 132 of the shoe retainer 1 adheres upon the lateral surface 23 of the pedal 2 to suffer from the lateral stress of the shoe retainer 1. Since the combining units 132 are elastic, when a force applies to the shoe retainer 1, the shoe retainer 1 can be interacted with the pedal 2. Thereby the assembly and detaching work can be done rapidly.

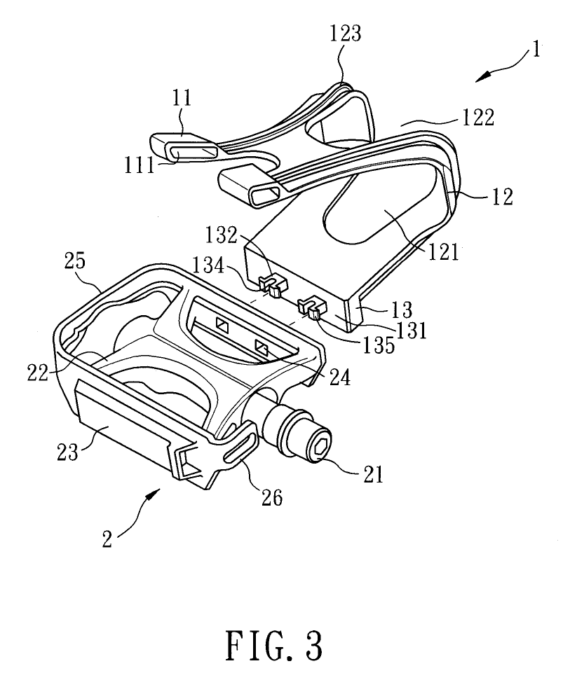

Referring to FIG. 3, the second embodiment of the present invention is illustrated. In this embodiment, those identical to the above embodiment will not be further described herein. Only those different from above embodiment are described. In this embodiment, the form of the combining seat 131 is changed. In this present invention, the two combining units 132 extend vertically from the front plane of the combining seat 131. That is, the two combining units 132 are vertically protruded from the combining seat 131. Each combining unit 132 is formed with a slit 134 at a central portion thereof and the two lateral sides of each combining unit 132 are installed with positioning blocks 135. The pedal 2 is formed with a combining groove 24 near a lateral surface 23 thereof. That is, the combining groove 24 is recessed from the lateral surface 23. Since each combining unit 132 is formed with a slit 134, thus it is elastic. The positioning blocks 135 are formed at two sides of each combining unit 132. Therefore, the shoe retainer 1 can separate the combining units 132 from the combining groove 24 from a horizontal direction of the treaded surface 22 of the pedal 2. Namely, the shoe retainer 1 separates the pedal 2 from a direction opposite to the direction embedding into the pedal 2. Thus, the present invention can be assembled and detached rapidly and quickly.

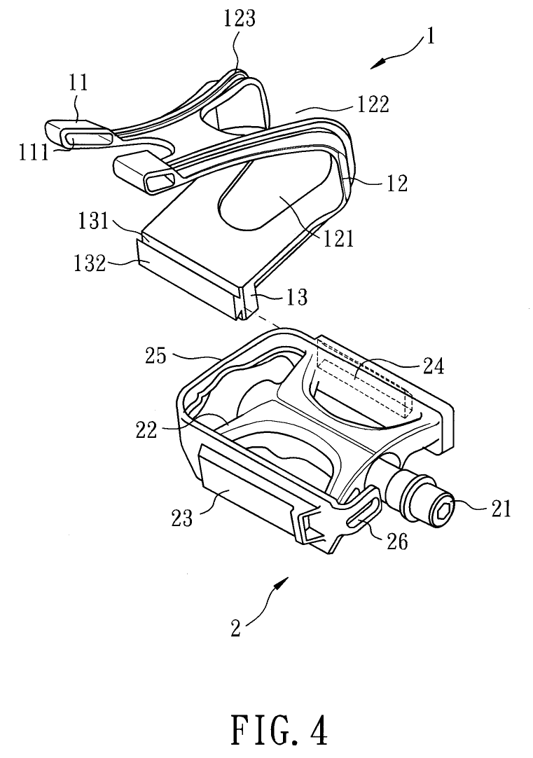

Referring to FIG. 4, the embodiment of embodiment is illustrated. In this embodiment, those identical to the above embodiment will not be further described herein. Only those different from above embodiment are described. In this embodiment, the combining unit 132 has a form like a dovetail and protrudes from the plane of the combining seat 131. The lateral surface 23 of the pedal 2 is formed with a combining groove 24 having a shape corresponding to that of the combining unit 132. The combining groove 24 is formed as a dovetail recess corresponding to the dovetail combining unit 132. The dovetail combining groove 24 is extended from the outer lateral surface 25 toward the inner lateral surface 26. Thus, the shoe retainer 1 can embed the combining unit 132 into the combining groove 24 from the inner lateral surface 26 to the outer lateral surface 25 so as to separate the pedal 2. That is, it is separate from the pedal 2 along a direction opposite to the shoe retainer 1 embedding into the combining unit 132. Thereby the assembly and detach work can be performed rapidly.

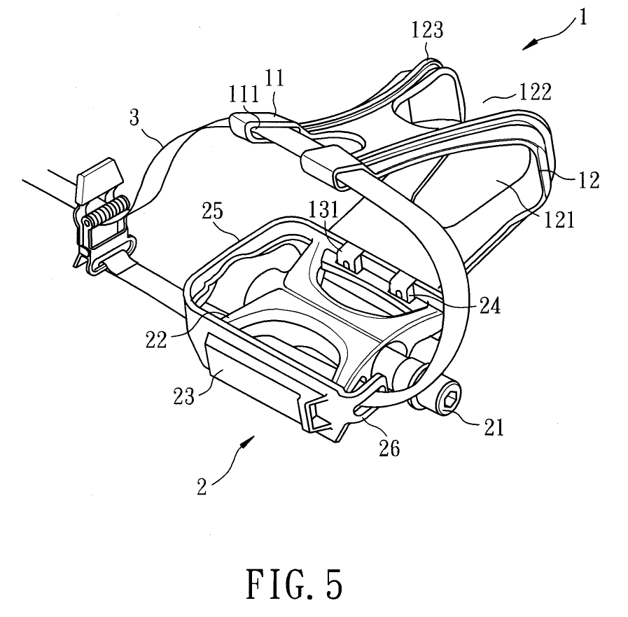

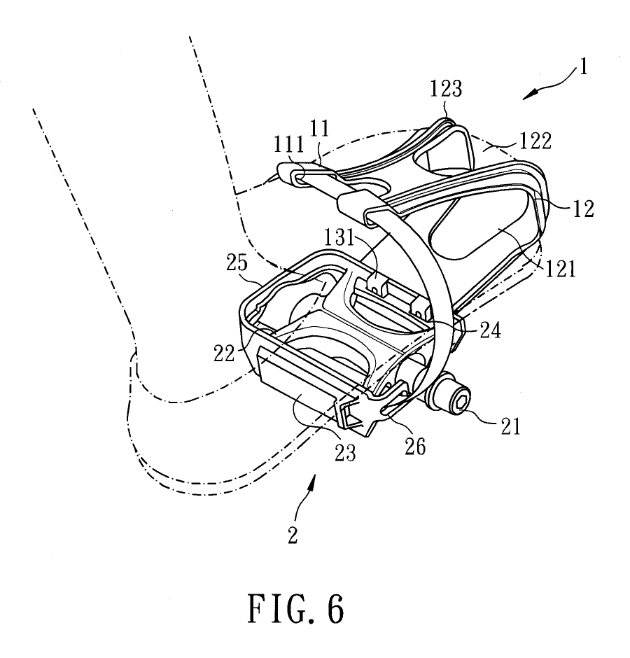

Referring to FIGS. 5 and 6, the two engaging holes 111 of the present invention serves to receive a buckling stripe 3. The buckling stripe 3 serves to fix the foot of the user. The combining units 132 of the shoe retainer 1 are directly assembled to the combining groove 24 of the pedal 2. Only a force will make the shoe retainer 1 to separate from the pedal 2 along an opposite direction. It also can place the shoe retainer 1 on the foot and then the buckling stripe 3 ties the foot to the shoe retainer 1. Then the foot treads or pushes along the assembly direction. The shoe retainer 1 can be tightly assembled to the pedal 2 so that it can be assembled and detached rapidly.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A positioning shoe retainer assembly of a bicycle comprising a shoe retainer and a pedal:
the shoe retainer having a retaining portion; the retaining portion installed with at least one engaging hole for retaining; an arc portion extending from the retaining portion; an inner side of the arc portion being formed with a receiving portion; the arc portion extending with a combining portion; a combining seat being installed with the combining portion; and at least one combining unit extending from the combining seat;
the pedal capable of being assembled to a bicycle by connecting to a shaft of a bicycle; a surface of the pedal adjacent to the shaft being an inner lateral surface; and a surface of the pedal opposite to the inner lateral surface being an outer lateral surface; an upper surface of the pedal being formed as a treaded surface for being treaded by users; two lateral surfaces being vertical to the treaded surface, the inner lateral surface and the outer lateral surface; the pedal being formed with at least one combining groove near the lateral surface; and
wherein in assembly, the shoe retainer is embedded into the combining groove of the pedal by using the combining unit so that the combining seat of the shoe retainer adheres upon the lateral surface of the pedal and the shoe retainer can separate from the pedal from a direction opposite to the direction that the shoe retainer embedded into the pedal; thus, by the shoe retainer being movably installed to the pedal, the shoe retainer can be assembled and detached rapidly.

2. The positioning shoe retainer assembly of a bicycle as claimed in claim 1, wherein each combining unit is curved to be parallel to a plane of the combining seat; and each combining unit is formed with at least one slit;
two sides of each combining unit have respective positioning blocks; the pedal has a combining groove in the treaded surface near the lateral surface;
the slit causes that the combining unit is flexible so that the combining seat can be embedded into the combining groove; the positioning blocks of the 5 combining unit resist against the combining groove for retaining the shoe retainer to the pedal.

3. The positioning shoe retainer assembly of a bicycle as claimed in claim 1, wherein each combining unit is vertical to a plane of the combining seat; and each combining unit is formed with at least one slit; two sides of each combining unit have respective positioning blocks; the pedal has a combining groove recessed from the lateral surface; the slit causes that the combining unit is flexible so that the combining seat can be embedded into the combining groove; the positioning blocks of the combining unit resist against the combining groove for retaining the shoe retainer to the pedal.

4. The positioning shoe retainer assembly of a bicycle as claimed in claim 1, wherein the combining unit has a dovetail shape and protrudes from the combining seat; a lateral surface of the pedal is installed with a combining groove corresponding to the combining unit; the combining groove is a dovetail recess which is formed from an outer lateral surface toward the inner lateral surface of the pedal, thereby the shoe retainer is embedded into the combining groove of the pedal from the outer lateral surface toward the inner lateral surface.
